(19) United States
(12) Patent Application Publication
(10) Pub. No.: US 2024/0317474 A1
(43) Pub. Date: Sep. 26, 2024

(54) Plastic packaging film for agricultural harvesting machinery

(71) Applicant: Jing ZHOU, Urumqi (CN)

(72) Inventor: Jing ZHOU, Urumqi (CN)

(21) Appl. No.: 18/679,570

(22) Filed: May 31, 2024

(30) Foreign Application Priority Data
May 22, 2024 (CN) 202421126421.4

(51) Int. Cl. B65D 65/14; A01F 15/07; B65D 65/22

(52) U.S. Cl. CPC B65D 65/14; B65D 65/22; A01F 15/071; A01F 2015/0745

(57) ABSTRACT

The invention relates to the technical field of plastic packaging film, in particular to a plastic packaging film for agricultural harvesting machinery, which comprises a plurality of packaging film pieces connected end to end and rolled into a roll, and is characterized in that a non-adhesive zone, a low-viscosity adhesive zone and a high-viscosity adhesive zone are successively arranged on the packaging film piece, the high-viscosity adhesive zone is arranged at the tail of the packaging film piece, and a traction detachment film is arranged at one end of the non-adhesive zone away from the low-viscosity adhesive zone; the high-viscosity adhesive zone of the previous packaging film piece is connected with the non-adhesive zone of the next packaging film piece through the traction detachment film. The invention aims to ensure the easy use of the packaging film.

### TECHNICAL FIELD

The invention relates to the technical field of plastic packaging film, in particular to a plastic packaging film for agricultural harvesting machinery.

### BACKGROUND ART

Plastic wrapping film plays a very important role in agricultural harvesting equipment, and is used to wrap crops such as hay, cotton, silage or corn to protect them from sunlight, rain and oxygen. The film has the functions of waterproofing, heat preservation, degradation, wind prevention, air permeability, etc., and can extend the storage time of crops in the field, thereby improving the harvesting efficiency and reducing losses. During use, farmers can quickly and evenly wrap the film on the surface of the crop through a special wrapping machine to ensure the tension and tightness of the film. Meanwhile, to facilitate the subsequent harvesting and transportation the wrapping film can also be simply cut and unpacked as needed.

In related technologies, to facilitate the packaging film to be rolled up, the packaging film is cut into a number of small segments. However, to roll up a number of small segments, it is necessary to provide a connecting adhesive layer at one end of each segment of packaging film piece to connect the adjacent packaging film piece and adhere a plurality of packaging film pieces into a whole, and the whole packaging film is rolled up and installed in the agricultural harvesting machinery for use. However, only the adhesive layer is used to connect, which is easy to damage the connection position when the packaging film is pulled out, and the single film has the problem of deviation during winding and transportation.

### SUMMARY OF THE INVENTION

The invention mainly aims at providing a plastic packaging film for agricultural harvesting machinery, aiming to ensure the easy use of the packaging film.

To achieve the above purpose, the plastic packaging film for agricultural harvesting machinery proposed by the invention comprises a plurality of packaging film pieces connected end to end and rolled into a roll, a non-adhesive zone, a low-viscosity adhesive zone and a high-viscosity adhesive zone are successively arranged on the packaging film piece, the high-viscosity adhesive zone is arranged at the tail of the packaging film piece, and a traction detachment film is arranged at one end of the non-adhesive zone away from the low-viscosity adhesive zone; the high-viscosity adhesive zone of the previous packaging film piece is connected with the non-adhesive zone of the next packaging film piece through the traction detachment film.

Preferably, the traction detachment film comprises a fold-back layer, a release film is arranged between the fold-back layer and the high-viscosity adhesive zone of the previous packaging film, the fold-back layer and the release film are connected through an adhesive zone, and the release film is connected with the high-viscosity adhesive zone.

Preferably, the traction detachment film also comprises a traction detachment film block, one end of the traction detachment film block is connected with the non-adhesive zone of the next packaging film piece through adhesive, and the other end is integrated with the fold-back layer.

Preferably, edge closing zones are arranged at both ends of the packaging film piece, and is arranged in a wide to narrow shape from the center of the packaging film piece to the end.

Preferably, edge wrapping zones are arranged on both sides of the packaging film piece, the edge wrapping zones on both sides are oppositely arranged and covered on the side edges of the non-adhesive zone, the low-viscosity adhesive zone and the high-viscosity adhesive zone. Preferably, the packaging film piece is provided with a stop tag, which is arranged in the low-viscosity adhesive zone and located at one end close to the high-viscosity adhesive zone.

Preferably, one or more RFID traceable tags are arranged on the non-adhesive zone.

Preferably, an easy-to-tear line is arranged at the connection between the previous packaging film piece and the next packaging film piece.

Preferably, the area of the non-adhesive zone is greater than that of the low-viscosity adhesive zone, and the area of the low-viscosity adhesive zone is greater than that of the high-viscosity adhesive zone.

In the technical proposal of the invention, a plurality of packaging film pieces are connected end to end to form a roll of packaging film; to make a roll of packaging film stably installed in the agricultural harvesting machinery and facilitate use, the packaging film piece comprises the non-adhesive zone, the low-viscosity adhesive zone and the high-viscosity adhesive zone, and the three adhesive zones are successively arranged on the packaging film piece, the non-adhesive zone is located at the head of the packaging film piece, the low-viscosity adhesive zone is located in the middle of the packaging film piece, the high-viscosity adhesive zone is arranged at the tail of the packaging film piece, the traction detachment film is arranged at the non-adhesive zone relative to the high-viscosity adhesive zone, and can be connected with the non-adhesive zone through the easy-to-tear line or the adhesive, the high-viscosity adhesive zone is connected to the traction detachment film to ensure the stable connection of the two packaging film pieces, the convenient separation structure design of the traction detachment film enables the two packaging film pieces to be separated more smoothly and conveniently, the arrangement of the non-adhesive zone is to ensure that the wrapped objects are not easily contaminated by the adhesive during the packaging process, the non-adhesive zone is arranged according to the packaging size, the low-viscosity adhesive zone is arranged after winding by one and a half circle, the function of the low-viscosity adhesive zone is to reduce the expansion coefficient by adhering to the non-adhesive zone and wrap the wrapped object to be tighter and firmer, the function of the high-viscosity adhesive zone is to completely solve the problem of unpacking due to strong bonding, the above structure can make the packaging film more convenient to use, and the winding state of a plurality of packaging film pieces is very stable, so that the packaging film is more convenient during production, storage, transportation and use. The separation action between the previous packaging film piece and the next packaging film piece is carried out when the automatic harvesting equipment senses the stop tag during use.

### BRIEF DESCRIPTION OF THE DRAWINGS

To describe the embodiments of the invention or the technical proposal in the prior art more clearly, the drawings to be used in the embodiments or the prior art are briefly introduced below. Obviously, the drawings below are only some embodiments of the invention. Ordinary technicians in the field can obtain other drawings according to the structure shown in these drawings without creative labor.

FIG. 1 is the structural diagram of the plastic packaging film for the agricultural harvesting machinery of the invention.

FIG. 2 is the structural diagram of one embodiment of the plastic packaging film for the agricultural harvesting machinery of the invention at the connection of the previous and next packaging film pieces.

FIG. 3 is the structural diagram of the joint of another embodiment of the plastic packaging film for the agricultural harvesting machinery of the invention at the connection of the previous and next packaging film pieces.

FIG. 4 is the winding state diagram of the plastic packaging film for the agricultural harvesting machinery of the invention.

### DESCRIPTION OF REFERENCE SIGNS

1. Packaging film piece; 2. Non-adhesive zone; 3. Low-viscosity adhesive zone; 4. High-viscosity adhesive zone; 5. Traction detachment film; 51. Fold-back layer; 52. Release film; 53. Traction detachment film block; 54. Adhesive zone; 6. Edge wrapping zone; 7. Edge closing zone; 8. Stop tag; 9. RFID traceable tag.

The realization of purpose, functional characteristics and advantages of the invention will be further explained in combination with the embodiments and with reference to the drawings.

### DETAILED DESCRIPTION OF THE INVENTION

To make the purpose, technical proposal and advantages of the application clearer, the application is further described in detail below in combination with the drawings and the embodiments. Understandably, the embodiments described herein are intended only to interpret the application and are not intended to limit the application.

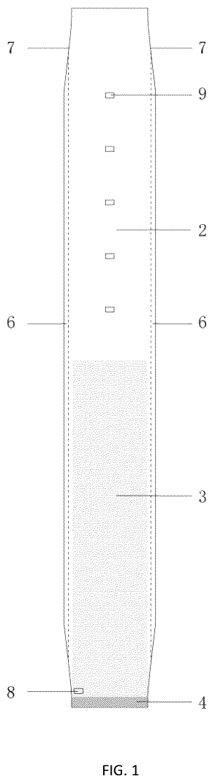

As shown in FIG. 1 to FIG. 5, a plastic packaging film for agricultural harvesting machinery proposed in one embodiment of the invention comprises a plurality of packaging film pieces 1 connected end to end and rolled into a roll, a non-adhesive zone 2, a low-viscosity adhesive zone 3 and a high-viscosity adhesive zone 4 are successively arranged on the packaging film piece 1, the high-viscosity adhesive zone 4 is arranged at the tail of the packaging film piece 1, and a traction detachment film 5 is arranged at one end of the non-adhesive zone 2 away from the low-viscosity adhesive zone 3; the high-viscosity adhesive zone 4 of the previous packaging film piece 1 is connected with the non-adhesive zone 2 of the next packaging film piece 1 through the traction detachment film 5.

In a plastic packaging film for the agricultural harvesting machinery in the application, a plurality of packaging film pieces 1 are connected end to end to form a roll of packaging film. To make a roll of packaging film stably installed in the agricultural harvesting machinery and convenient for use, the packaging film piece 1 comprises the non-adhesive zone 2, the low-viscosity adhesive zone 3 and the high-viscosity adhesive zone 4, and the three adhesive zones are successively arranged on the packaging film piece 1, the non-adhesive zone 2 is located at the head of the packaging film piece 1, the low-viscosity adhesive zone 3 is located in the middle of the packaging film piece 1, the high-viscosity adhesive zone 4 is arranged at the tail of the packaging film piece 1, the traction detachment film 5 is arranged at the non-adhesive zone 2 relative to the high-viscosity adhesive zone 4, and can be connected with the non-adhesive zone 2 of the packaging film piece 1 at the position close to the easy-to-tear line, the high-viscosity adhesive zone 4 is connected to the traction detachment film 5 to ensure the stable connection of the two packaging film pieces 1, and the convenient separation structure design of the traction detachment film 5 enables the two packaging film pieces 1 to be separated more smoothly and conveniently.

When the article is wrapped, the non-adhesive zone 2 is first wrapped around the outer surface of the article, and the packaging film piece 1 continuous to wrap the article. At this time, the low-viscosity adhesive zone 3 is wrapped around the outer surface of the non-adhesive zone 2 to play a fixing role, and then the packaging film 1 continues to wrap the article, and the high-viscosity adhesive zone 4 is wrapped around the outer surface of the low-viscosity adhesive zone 3 to seal the article.

The non-adhesive zone 2 lies in the fact that the wrapped object is not easily contaminated by adhesive during the packaging process. In the embodiment, the adhesive viscosity of low-viscosity adhesive zone 3 is weaker than that of the high-viscosity adhesive zone 4, and the adhesive strength of the two is relative, without value limit.

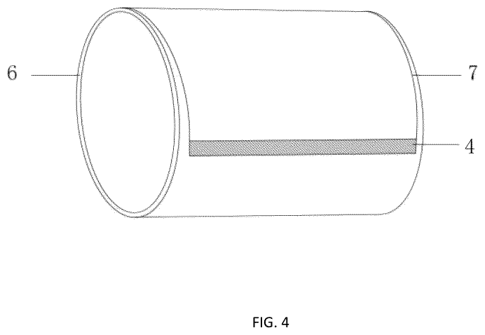

As shown in FIG. 3 to FIG. 4, in one embodiment of the application, the traction detachment film 5 comprises a fold-back layer 51, a release film 52 is arranged between the fold-back layer 51 and the high-viscosity adhesive zone 4 of the previous packaging film piece 1, the fold-back layer 51 and the release film 52 are connected through an adhesive zone 54, and the release film 52 is connected with the high-viscosity adhesive zone 4. An easy-to-tear line is arranged at the connection between the previous packaging film piece 1 and the next packaging film piece 1, and the traction detachment film 5 can be connected with the non-adhesive zone 2 of the packaging film piece 1 at the position close to the easy-to-tear line.

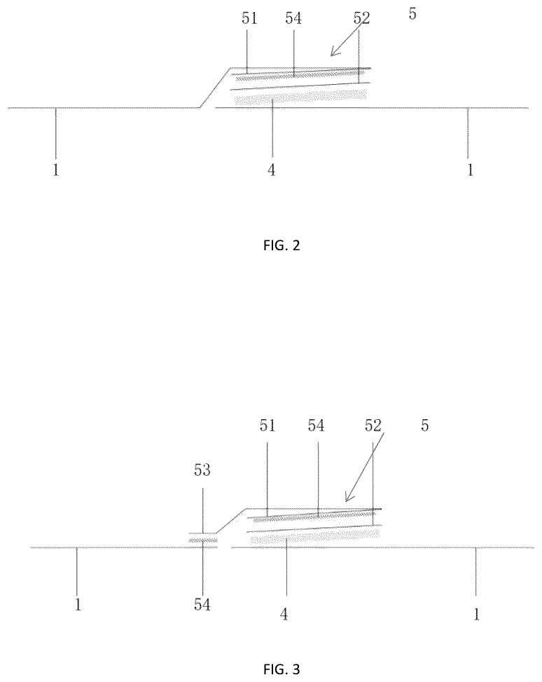

As shown in FIG. 2 to FIG. 4, in one embodiment of the application, the traction detachment film 5 also comprises a traction detachment film block 53, one end of the traction detachment film block 53 is connected with the non-adhesive zone 2 of the next packaging film piece 1 through adhesive, and the other end is integrated with the fold-back layer.

In a plastic packaging film for the agricultural harvesting machinery in the application, the traction detachment film 5 also comprises a traction detachment film block 53, which is bonded to the non-adhesive zone 2 of the next packaging film piece 1, the fold-back layer 51 of the traction detachment film 5 is directly bonded to the traction detachment film block 53; the previous and next packaging film pieces 1 are easily bonded by arranging the traction detachment film block 53, and can be separated more conveniently to avoid the damage to the next packaging film piece 1 caused by the strong viscosity of the high-viscosity adhesive zone 4 when the two packaging film pieces 1 are separated.

As shown in FIG. 1 to FIG. 5, in one embodiment of the application, edge closing zones 7 are arranged at both ends of the packaging film piece 1, and are arranged in a wide to narrow shape from the center of the packaging film piece 1 to the end.

In a plastic packaging film for the agricultural harvesting machinery in the application, the edge closing zones 7 are arranged at both ends of the packaging film piece 1, and are narrowed to the reasonable size of the equipment from wide to narrow, achieving smooth film feeding, smooth edge wrapping on both sides, sealing and bonding of wrapped object and longer storage time.

As shown in FIG. 1 to FIG. 5, in one embodiment of the application, edge wrapping zones 6 are arranged on both sides of the packaging film piece 1, the edge wrapping zones 6 on both sides are oppositely arranged and covered on the side edges of the non-adhesive zone 2, the low-viscosity adhesive zone 3 and the high-viscosity adhesive zone 4.

In a plastic packaging film for the agricultural harvesting machinery in the application, two edge wrapping zones 6 are arranged on the side edges of the packaging film piece 1, which is convenient for the edge folding of both sides during use, the wrapped object is not easy to fall off, water does not easily infiltrate, and the wrapped object is wrapped firmly.

As shown in FIG. 1, in one embodiment of the application, A stop tag 8 is arranged on the packaging film piece 1 and is arranged at the end of the low-viscosity adhesive area 3 near the high-viscosity adhesive area 4.

In a plastic packaging film for the agricultural harvesting machinery in the application, the stop tag 8 is arranged at the rear of each unit wrapping film piece, and the separation action between the previous packaging film piece and the next packaging film piece is carried out when the automatic harvesting equipment senses the stop tag during use.

As shown in FIG. 1, in one embodiment of the application, one or more RFID traceable tags 9 are arranged on the packaging film piece 1, and are arranged in the non-adhesive zone 2.

In a plastic packaging film for the agricultural harvesting machinery in the application, one or more RFID traceable tags 9 are arranged on each unit wrapping film piece, which is convenient to trace the harvest time, harvest location, harvest weight and harvest humidity and more convenient for the work of the next operator. In the embodiment, a plurality of RFID traceable tags 9 are arranged in the non-adhesive zone 2 because the low-viscosity adhesive zone 3 is provided with an adhesive layer and the thickness will increase, thereby facilitating more convenient use of the traceable tags; of course, the RFID traceable tags 9 arranged in the low-viscosity adhesive zone 3 or other locations can also work normally.

As shown in FIG. 2 to FIG. 4, in one embodiment of the application, the high-viscosity adhesive zone 4 is arranged between the traction detachment film 5 and the non-adhesive zone 2, and the non-adhesive zone 2 is covered on the outer edge of the high-viscosity adhesive zone 4.

In a plastic packaging film for the agricultural harvesting machinery in the application, the traction detachment film 5 and the non-adhesive zone 2 are connected through the high-viscosity adhesive zone 4, which is directly arranged in the non-adhesive zone 2 during the production of packaging film pieces 1, so that the high-viscosity adhesive zone 4 can be very tightly adhered to the traction detachment film 5 and the non-adhesive zone 2, the ends can be bonded and compounded into a roll shape by the automatic compound equipment, which is easier to use on automatic harvesting machinery and facilitates storage; meanwhile, when the adjacent packaging film pieces 1 need to be separated, the separation speed is more rapid and stable, and it is not easy to damage the packaging film pieces 1, thereby making the use of the entire packaging film more convenient.

As shown in FIG. 1, in one embodiment of the application, the area of the non-adhesive zone 2 is greater than that of the low-viscosity adhesive zone 3, and the area of the low-viscosity adhesive zone 3 is greater than that of the high-viscosity adhesive zone 4.

It should be noted here that the area of the non-adhesive zone 2, the area of the low-viscosity adhesive zone 3, and the area of high-viscosity adhesive zone 4 can be set as required. To facilitate wrapping operation and achieve tight and reasonable packaging, the above settings are preferred.

Identical or similar signs in the drawings to the embodiment correspond to identical or similar components; in the description of the application, it should be understood that where the orientation or position relationships indicated by the terms such as “upper”, “lower”, “left” and “right” are based on the orientation or position relationships shown in the drawings, the terms are only for the purpose of facilitating the description of the application and simplifying the description, and not to indicate or imply that a device or element referred to must have a specific orientation, or be constructed and operated in a specific orientation. Therefore, the terms used to describe the position relationships in the drawings are for illustrative purposes only and cannot be construed as a limitation to the patent. Ordinary technicians in the field can understand the specific meaning of the terms according to the specific circumstances.

The above embodiments are only preferred embodiments of the application and are not intended to limit the application. Any modification, equivalent substitution, improvement, etc. made within the spirit and principles of the application should fall within the scope of protection of the application.

1. A plastic packaging film for agricultural harvesting machinery, comprising a plurality of packaging film pieces connected end to end and rolled into a roll, and characterized in that a non-adhesive zone, a low-viscosity adhesive zone and a high-viscosity adhesive zone are successively arranged on the packaging film piece, the high-viscosity adhesive zone is arranged at the tail of the packaging film piece, and a traction detachment film is arranged at one end of the non-adhesive zone away from the low-viscosity adhesive zone;
the high-viscosity adhesive zone of the previous packaging film piece is connected with the non-adhesive zone of the next packaging film piece through the traction detachment film.

2. The plastic packaging film for the agricultural harvesting machinery according to claim 1, characterized in that the traction detachment film comprises a fold-back layer, a release film is arranged between the fold-back layer and the high-viscosity adhesive zone of the previous packaging film piece, the fold-back layer and the release film are connected through an adhesive zone, and the release film is connected with the high-viscosity adhesive zone.

3. The plastic packaging film for the agricultural harvesting machinery according to claim 2, characterized in that the traction detachment film also comprises a traction detachment film block, one end of the traction detachment film block is connected with the non-adhesive zone of the next packaging film piece through adhesive, and the other end is integrated with the fold-back layer.

4. The plastic packaging film for the agricultural harvesting machinery according to claim 1, characterized in that edge closing zones are arranged at both ends of the packaging film piece, and are arranged in a wide to narrow shape from the center of the packaging film piece to the end.

5. The plastic packaging film for the agricultural harvesting machinery according to claim 4, characterized in that edge wrapping zones are arranged on both sides of the packaging film piece, the edge wrapping zones on both sides are oppositely arranged and covered on the side edges of the non-adhesive zone, the low-viscosity adhesive zone and the high-viscosity adhesive zone.

6. The plastic packaging film for the agricultural harvesting machinery according to claim 1, characterized in that the packaging film piece is provided with a stop tag, which is arranged in the low-viscosity adhesive zone and located at one end close to the high-viscosity adhesive zone.

7. The plastic packaging film for the agricultural harvesting machinery according to claim 1, characterized in that one or more RFID traceable tags are arranged on the non-adhesive zone.

8. The plastic packaging film for the agricultural harvesting machinery according to claim 1, characterized in that an easy-to-tear line is arranged at the connection between the previous packaging film piece and the next packaging film piece.

9. The plastic packaging film for the agricultural harvesting machinery according to claim 1, characterized in that the area of the non-adhesive zone is greater than that of the low-viscosity adhesive zone, and the area of the low-viscosity adhesive zone is greater than that of the high-viscosity adhesive zone.
